(19) United States
(12) Patent Application Publication
(10) Pub. No.: US 2025/0279507 A1
(43) Pub. Date: Sep. 4, 2025

(54) HEAT MANAGEMENT STRUCTURE FOR BATTERY CELL

(71) Applicant: Korea University Research and Business Foundation, Seoul (KR)

(72) Inventors: Ho Seong LEE, Seoul (KR); Seung Hoon LEE, Seoul (KR)

(73) Assignee: Korea University Research and Business Foundation, Seoul (KR)

(21) Appl. No.: 18/859,089

(22) PCT Filed: Apr. 20, 2023
(86) PCT No.: PCT/KR2023/005383

§ 371 Date: Oct. 22, 2024

(30) Foreign Application Priority Data
Jan. 19, 2023 (KR) 10-2023-0008005

(51) Int. Cl. H01M 10/659; H01M 10/613; H01M 10/647; H01M 10/6551; H01M 50/211

(52) U.S. Cl. CPC H01M 10/659; H01M 10/613; H01M 10/647; H01M 10/6551; H01M 50/211

(57) ABSTRACT

Disclosed is a thermal management structure of a battery cell, the thermal management structure including: a plurality of battery cells repeatedly arranged; a cell cooler connected to one side of each of the battery cells to enable heat transfer, and configured to cool the battery cell or raise the temperature of the battery when necessary; and a hybrid phase change material (PCM) part respectively disposed between the battery cells to absorb heat generated from the battery cells, and formed of different types of phase change materials (PCMs) respectively disposed in a plurality of divided regions divided in a shape of corresponding to a temperature gradient pattern of the battery cells.

### TECHNICAL FIELD

The present invention relates to a thermal management structure of a battery cell, and more particularly to a battery cell which is applied with a hybrid phase change material (PCM) part made of different types of phase change materials to reduce a temperature deviation dependent upon the location of the battery cell and increase the cooling performance and temperature rise performance of the battery cell.

### BACKGROUND ART

In general, batteries are widely used in electrical devices that cannot be connected by wire, such as portable electronic devices, mobile communication terminals, and electric vehicles. As a result, battery research and development is becoming more active as the battery market expands, but accidents in which batteries catch fire or explode still occur frequently.

Battery fires or explosions as described above occur for various reasons such as damage due to impact, design errors, short circuits, and harsh usage environments, and it is still difficult to completely prevent them.

The distribution of electric vehicles has been rapidly expanding in recent years. High-capacity battery packs are used in conventional electric vehicles. It is important to increase the performance and capacity of such electric vehicle battery packs, but it is also very important to prevent casualties and property damage due to fire and explosion. For this, research and development have recently been actively conducted to develop battery packs with all of high capacity, high efficiency, and high safety.

In particular, the purpose is to increase charging efficiency and improve fuel efficiency by delaying the temperature rise that occurs in the battery cell of a battery pack during rapid charging and harsh driving conditions of electric vehicles. Furthermore, technologies to reduce the risk of fire and explosion of battery modules due to abnormalities in a battery cell due to temperature rise are continuously being researched and developed. Recently, attempts have been made to improve the cooling performance of a battery cell by using phase change materials (PCM) that absorb more heat during a phase change process.

Meanwhile, the conventional method of performing thermal management of a battery cell by placing a cooling plate at the bottom of the battery cell is widely used, but, in the case of this conventional method, not only a very large temperature gradient occurs within the battery cell due to the temperature difference between an inlet and outlet of a coolant supplied to a cooling plate, but also there is a temperature difference between the upper and lower parts of the battery cell due to the cooling plate located at the bottom. This temperature gradient within a battery cell leads to differences in the degree of internal deterioration of the battery cell, and, if the battery cell is continuously operated with a large temperature gradient within the battery cell, there is a high possibility that major problems may occur regarding the stability and lifespan of the battery cell.

Accordingly, technology is being developed to apply a separate heat pipe or cooling system to solve the temperature difference between battery cells or the temperature difference between the upper part and lower part of the battery cells, but there are limitations in that the structure and control method becomes complex and the overall weight increases significantly.

The present invention relates to the technology “STUDY ON OPTIMIZATION OF THERMAL MANAGEMENT SYSTEM OF NEXT-GENERATION HIGH ENERGY DENSITY BATTERY USING COMPLEX PHASE CHANGE HEAT TRANSFER PACKAGE (project number: 1711162708, Research period: Mar. 1, 2019˜Feb. 28, 2023)” developed by the Korea University Industry-Academic Cooperation Foundation through a research project funded by the Ministry of Science and ICT.

### DISCLOSURE

### Technical Problem

Therefore, the present invention has been made in view of the above problems, and it is one object of the present invention to provide a battery cell which is applied with a hybrid PCM part made of different types of phase change materials to reduce a temperature deviation of the battery cell and, thus, increase the cooling performance of the battery cell, thereby increasing the stability and lifespan of the battery cell.

It is another object of the present invention to provide a thermal management structure of a battery cell which is capable of acting as a heat buffer to absorb heat generated from a battery cell using the latent heat of a hybrid PCM part during rapid charging, and of improving the lifespan of the battery cell and helping ensure the operation stability thereof by minimizing a temperature deviation in the battery cell during cooling or heating.

### Technical Solution

In accordance with an aspect of the present invention, the above and other objects can be accomplished by the provision of a thermal management structure of a battery cell, the thermal management structure including: a plurality of battery cells repeatedly arranged; a cell cooler connected to one side of each of the battery cells to enable heat transfer, and configured to cool the battery cell or raise a temperature of the battery when necessary; and a hybrid phase change material (PCM) part respectively disposed between the battery cells to absorb heat generated from the battery cells, and formed of different types of phase change materials (PCMs) respectively disposed in a plurality of divided regions divided in a shape of corresponding to a temperature gradient pattern of the battery cells.

Preferably, the hybrid PCM part may be divided into a plurality of divided regions according to the temperature gradient pattern of the battery cells. Here, the PCMs disposed in the divided regions may be provided to have different thermal conductivities.

For example, a PCM having a relatively high thermal conductivity among the PCMs may be disposed in the divided regions as a temperature of the battery cells corresponding to the divided regions increases, and a PCM having a relatively low thermal conductivity among the PCMs may be disposed in the divided regions as a temperature of the battery cells corresponding to the divided regions is lowered.

Preferably, the hybrid PCM part may be formed of: a reference PCM formed only of a pure PCM; and a synthetic PCM formed to have higher thermal conductivity than the reference PCM by synthesizing a heat transfer material having a higher thermal conductivity than the reference PCM with the reference PCM.

Thermal conductivity of the synthetic PCM may be changed by adjusting a content of the heat transfer material synthesized in the reference PCM.

The heat transfer material may include at least one of a metal foam, carbon-based material, metal pin and nanomaterial having higher thermal conductivity than the reference PCM.

Preferably, the thermal management structure according to an embodiment of the present invention may further include a fin member made of metal, wherein the fin member contacts one surface of the hybrid PCM part to enable heat transfer, one side of the fin member is connected to the cell cooler, and the fin member serves as a heat transfer path between the hybrid PCM part and the cell cooler.

Preferably, the thermal management structure according to an embodiment of the present invention may further include a heat transfer sheet, wherein the heat transfer sheet is attached to one surface of the fin member in contact with the hybrid PCM part and formed of a material with higher thermal conductivity than the fin member to increase heat transfer performance of the fin member.

The heat transfer sheet may be formed of a graphite material.

### Advantageous Effects

In a thermal management structure of a battery cell according to an embodiment of the present invention, a hybrid phase change material (PCM) part made of different types of phase change materials is applied to the battery cell, so that a temperature deviation dependent upon the location of the battery cell can be reduced. Accordingly, the cooling performance of the battery cell can be improved, thereby increasing the stability and lifespan of the battery cell.

In addition, the thermal management structure of the battery cell according to an embodiment of the present invention absorbs the rapid amount of heat rapidly generated from the battery cell using the latent heat of the hybrid PCM during rapid charging of the battery cell, so that the hybrid PCM can serves as a heat buffer, and a temperature deviation between regions of the battery cell can be minimized by the hybrid PCM during cooling or heating of the battery cell. Accordingly, the lifespan of the battery cell can be improved, and the operational safety of the battery cell can be ensured.

In addition, since the thermal management structure of the battery cell according to an embodiment of the present invention has a structure wherein a hybrid PCM, a heat transfer sheet and a fin member are respectively disposed between the battery cells, heat generated from the battery cells can be smoothly transferred to a cell cooler through the hybrid PCM, the heat transfer sheet and the fin member, and when the temperature of the battery cell increases, heat transferred from the cell cooler can be easily transferred to the battery cells.

In addition, since the thermal management structure of the battery cell according to an embodiment of the present invention has a structure wherein the hybrid PCM part is divided into a plurality of divided regions according to a temperature gradient pattern dependent upon the position of the battery cells, and then the divided regions are formed of PCMs having different thermal conductivities, the temperature gradient dependent upon the position of the battery cells can be appropriately removed by the hybrid PCM part formed of PCMs with different thermal conductivities. Accordingly, the temperature deviation of the battery cells can be reduced, thereby improving the performance and stability of the battery cells.

In addition, since the thermal management structure of the battery cell according to an embodiment of the present invention has a structure wherein a thermally conductive sheet having high thermal conductivity is disposed between the hybrid PCM and the fin member, the heat transfer efficiency between the hybrid PCM and the cell cooler can be increased, and heat transfer to a specific part of the battery cell which is far away from the cell cooler can be stably achieved. Accordingly, the temperature deviation between the battery cells can be reduced by the hybrid PCM part and the thermally conductive sheet.

In addition, since the hybrid PCM part of the thermal management structure of the battery cell according to an embodiment of the present invention is manufactured in the form of a thin pouch, and the heat transfer sheet thereof is manufactured in a thin film shape, the weight and size of the battery cells do not significantly increase even if the hybrid PCM and the heat transfer sheet are disposed between the battery cells. Accordingly, the battery cells can be manufactured compactly.

Further, since a temperature deviation between the battery cells in the thermal management structure of the battery cell according to an embodiment of the present invention is reduced by the hybrid PCM and the thermally conductive sheet, it is possible to prevent the temperature of a specific region in the battery cells from increasing abnormally, and fire and explosion of the battery cells due to an abnormal increase in the temperature of the battery cells can be effectively prevented.

### DESCRIPTION OF DRAWINGS

FIG. 1 schematically illustrates a thermal management structure of a battery cell according to an embodiment of the present invention.

FIG. 2 illustrates an exploded perspective view of a main part of the thermal management structure of the battery cell shown in FIG. 1.

FIG. 3 illustrates heat transfer paths according to cooling and temperature increase in a battery cell shown in FIG. 2.

FIG. 4 illustrates another embodiment of the thermal management structure of the battery cell shown in FIG. 2.

FIG. 5 illustrates modified examples of hybrid phase change material (PCM) parts shown in FIGS. 2 and 4.

FIG. 6 illustrates a set of graphs representing the maximum temperature and maximum temperature deviation of the battery cell during rapid charging of the battery cell shown in FIG. 1.

FIG. 7 illustrates a set of graphs representing the maximum and minimum temperatures of the battery cell when the temperature of the battery cell shown in FIG. 1 increases.

### BEST MODE

The present invention will now be described more fully with reference to the accompanying drawings, in which exemplary embodiments of the invention are shown. This invention may, however, be embodied in many different forms and should not be construed as limited to the exemplary embodiments set forth herein. Like reference numerals in the drawings denote like elements.

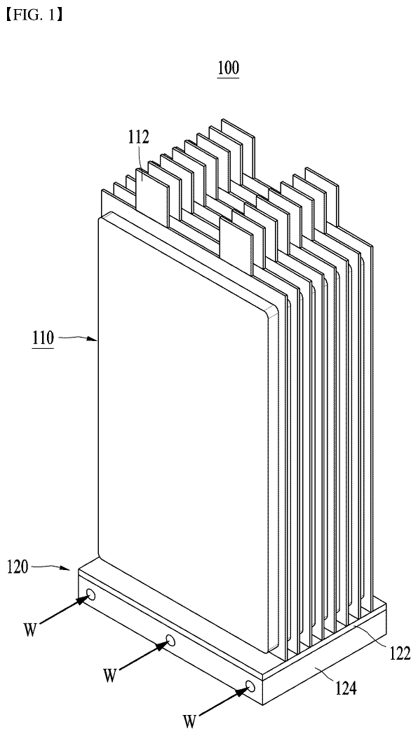

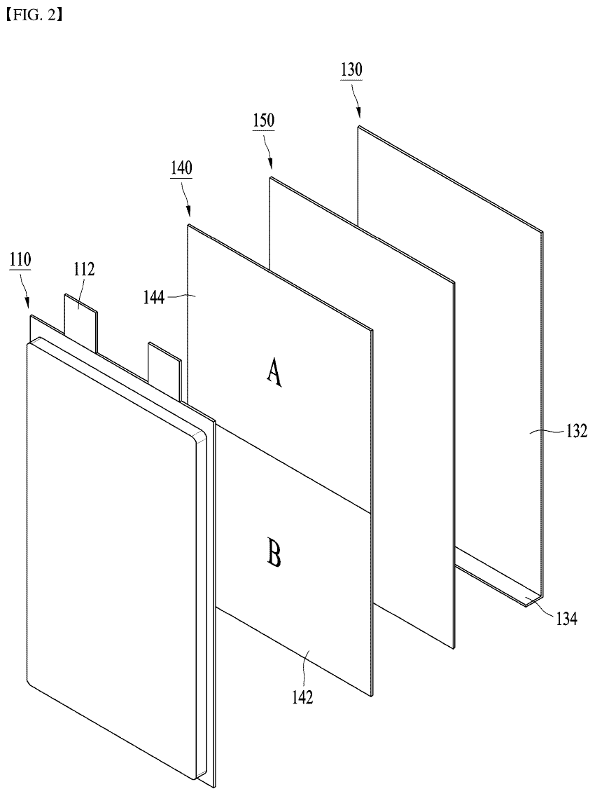

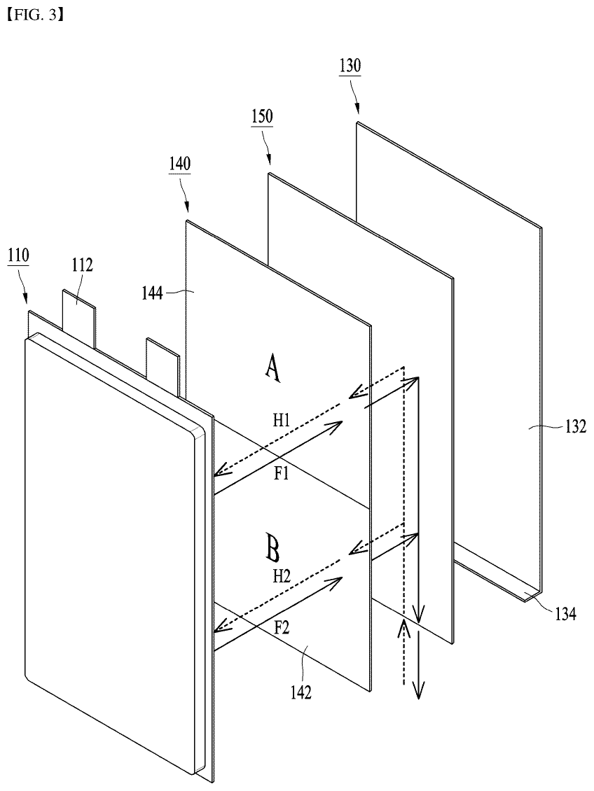

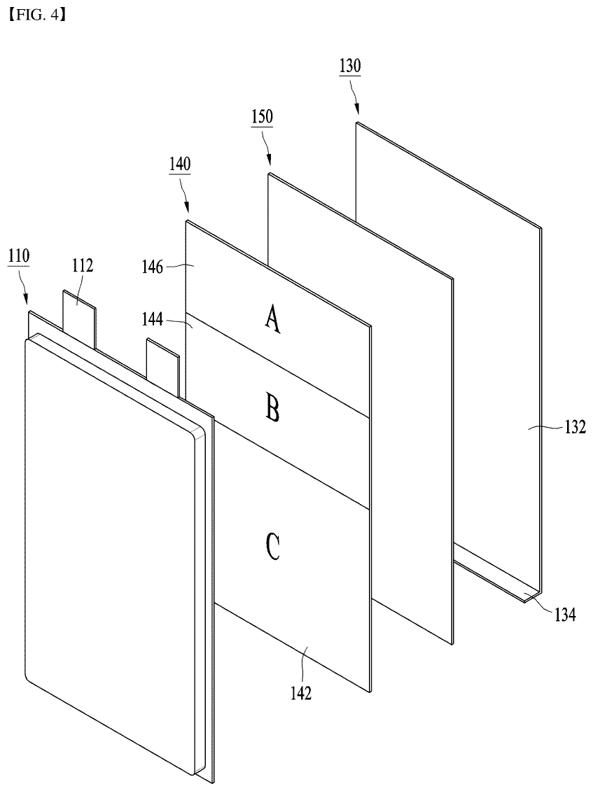

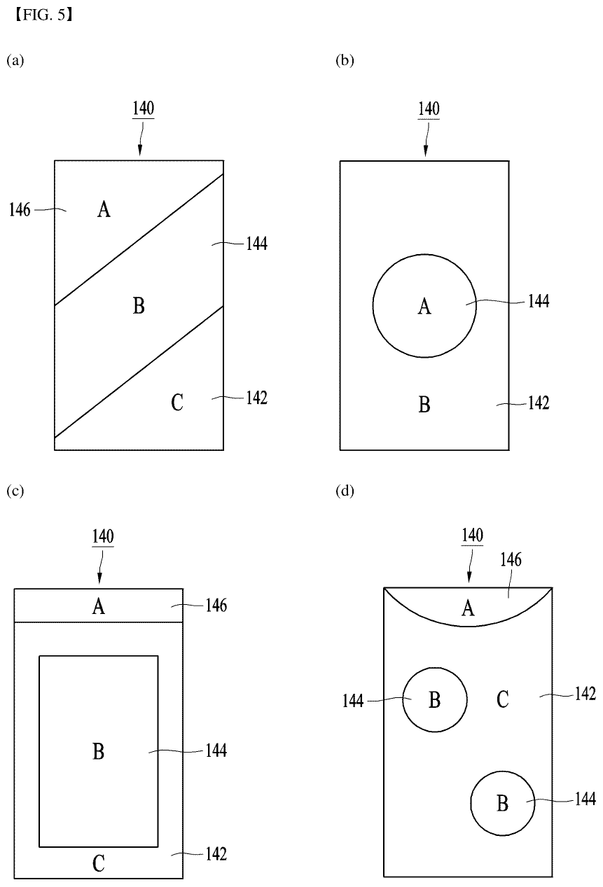

FIG. 1 schematically illustrates a thermal management structure 100 of a battery cell according to an embodiment of the present invention, FIG. 2 illustrates an exploded perspective view of a main part of the thermal management structure 100 of the battery cell shown in FIG. 1, and FIG. 3 illustrates heat transfer paths according to cooling and temperature increase in a battery cell 110 shown in FIG. 2. FIG. 4 illustrates another embodiment of the thermal management structure 100 of the battery cell shown in FIG. 2, and FIG. 5 illustrates modified examples of hybrid phase change material (PCM) parts 140 shown in FIGS. 2 and 4.

Referring to FIGS. 1 to 4, the thermal management structure 100 of the battery cell according to an embodiment of the present invention may include a battery cell 110, a cell cooler 120, a fin member 130, a hybrid PCM part 140, and a heat transfer sheet 150.

In the thermal management structure 100 of the battery cell of this embodiment, the battery cell 110 is described as being formed as a rectangular thin plate structure, but is not limited thereto and may be formed in a different shape. In this embodiment, for convenience of explanation of the thermal management structure 100 of the battery cell, a description will be made with a front-back direction, up-down direction, and left-right direction set in advance.

For example, the battery cell 110 may be arranged in a structure standing on an upper side of the cell cooler 120, and may include a plurality of cells arranged alternately in a front-to-back direction. In addition, the cell cooler 120 may be connected to a lower part of the battery cell 110, and cell taps 112 of the battery cell 110 may be disposed on an upper part of the battery cell 110.

Referring to FIGS. 1 to 3, the present invention may include a plurality of battery cells 110 repeatedly arranged. These battery cells 110 are components in which electricity is charged and discharged, and may be accommodated inside a battery module housing (not shown). Typically, the temperature of the battery cells 110 may increase as heat is generated during a charging and discharging process.

Here, the plural battery cells 110 may be repeatedly arranged in close contact with each other along the front-back direction. On the upper part of the battery cell 110, the cell taps 112 may extend long upward. For reference, the lower part of the battery cell 110 may be connected to an upper surface of the cell cooler 120 to enable heat transfer.

Referring to FIG. 1, the cell cooler 120 of this embodiment may be connected to the lower part of the battery cell 110 to enable heat transfer to cool the battery cell 110 or raise the temperature when necessary. That is, the cell cooler 120 may cool the battery cell 110 when using the battery module to prevent overheating of the battery cell 110 and the resulting efficiency decrease, or raise the temperature of the battery cell 110 in a cold environment or before actual use to preheat the battery cell 110.

For example, the cell cooler 120 may include a cooling plate 122 and a heating sink 124.

The cooling plate 122, which is a component connected to the lower part of the battery cell 110, may transfer heat generated by the battery cell 110 to the heating sink 124 when cooling the battery cell 110, and may transfer heat from the heating sink 124 to the battery cell 110 when the temperature of the battery cell 110 increases. For this, the cooling plate 122 may be made of a metal material with high thermal conductivity. For reference, a gap filler with excellent thermal conductivity may be arranged between the cooling plate 122 and the lower part of the battery cell 110 to eliminate a gap between the cooling plate 122 and the battery cell 110.

The heating sink 124 may absorb heat transferred from the battery cell 110 to the cooling plate 122 and then discharge it to the outside when the battery cell 110 is cooled, and may provide heat to be transferred to the battery cell 110 to the cooling plate 122 when the temperature of the battery cell 110 is increased. For this, the heating sink 124 may be connected onto a bottom surface of the cooling plate 122 to enable heat transfer.

For example, the heating sink 124 may cool or raise the temperature of the cooling plate 122 using a coolant W flowing in from the outside. Here, the coolant W may cool or heat to a desired temperature through a separate heat pump system placed outside the battery module.

Referring to FIGS. 1 to 3, the fin member 130 of this embodiment may serve as a heat transfer path between the hybrid PCM part 140 and the cell cooler 120. The fin member 130 may be formed of a metal material with high thermal conductivity, and, in this embodiment, it is described as being made of aluminum. Here, the fin member 130 may be in contact with one surface of the hybrid PCM part 140 to enable heat transfer. In addition, a lower part of the fin member 130 may be seated on the cooling plate 122 of the cell cooler 120 to enable heat transfer.

For example, the fin member 130 may include a fin panel 132 in contact with one surface of the hybrid PCM part 140; and a pin seating part 134 provided in a flange shape at a lower end of the fin panel 132 and seated on the cooling plate 122. Here, the contact surface of the fin panel 132 may be provided in a shape corresponding to one surface of the hybrid PCM part 140, and the pin seating part 134 may be connected to the cooling plate 122 to enable heat transfer.

Referring to FIGS. 1 to 3, the hybrid PCM part 140 of this embodiment may be respectively disposed between the plural battery cells to absorb heat generated from the battery cell 110. Such a hybrid PCM part 140 may be provided as a thin pouch structure that accommodates various types of PCMs 142 and 144. Accordingly, even if the hybrid PCM part 140 is installed between the battery cells 110, the battery module may be formed compactly and simply without significantly increasing the size and weight of the battery module.

Here, a plurality of divided regions A and B divided into a shape corresponding to the temperature gradient pattern of the battery cell 110 may be respectively formed in the hybrid PCM part 140. The location and number of the divided regions A and B of the hybrid PCM part 140 as described above may be determined depending upon the temperature gradient pattern of the battery cell 110, and the divided regions A and B may be respectively made of different types of phase change materials (PCMs) 142 and 144.

Specifically, the hybrid PCM part 140 may be divided into the plural divided regions A and B according to the temperature gradient pattern of the battery cell 110. Here, the PCMs 142 and 144 placed in the divided regions A and B may have different thermal conductivities depending on the temperature gradient of the battery cell 110.

That is, the synthetic PCM 144, which has relatively high thermal conductivity, among the PCMs 142 and 144 may be disposed in the first divided region A, in which the temperature of the battery cell 110 is relatively high, among the divided regions A and B. On the other hand, the reference PCM 142, which has relatively low thermal conductivity, among the PCMs 142 and 144 may be disposed in the second divided region B, in which the temperature of the battery cell 110 is relatively low, among the divided regions A and B.

Therefore, the region of the battery cell 110 with a high temperature may be cooled or heated up more quickly than the region of the battery cell 110 with a low temperature through the synthetic PCM 144 of the first divided region A. Since such a temperature deviation of the battery cell 110 is compensated by a thermal conductivity difference between the PCMs 142 and 144 of the hybrid PCM part 140, the entire battery cell 110 may be cooled or heated without temperature deviation through the thermal management structure 100 of this embodiment.

For example, the hybrid PCM part 140 may be formed of the reference PCM 142 formed only of a pure PCM; and the synthetic PCM 144 formed to have higher thermal conductivity than the reference PCM 142 by synthesizing the reference PCM 142 with a heat transfer material (not shown) having higher thermal conductivity than the reference PCM 142.

Here, the reference PCM 142 may be formed only of a paraffin-based material with low thermal conductivity.

In addition, the thermal conductivity of the synthetic PCM 144 may be changed by adjusting the content of a heat transfer material synthesized in the reference PCM 142. The heat transfer material may include at least one of metal foam, carbon-based materials, metal pins, nanomaterials and paraffin-substituting materials which have higher thermal conductivity than the reference PCM 142.

For reference, the compositions of the reference PCM 142 and the synthetic PCM 144 are not limited to the above-described compositions, and may be manufactured in various compositions depending on the design conditions and circumstances for the thermal management structure 100 of the battery cell.

Referring to FIGS. 2 to 3, the heat transfer sheet 150 of this embodiment may be attached to one surface of the fin member 130 that is in contact with the hybrid PCM part 140. The heat transfer sheet 150 may be formed of a material with higher thermal conductivity than the fin member 130 to further increase the heat transfer performance of the fin member 130. For example, the heat transfer sheet 150 may be formed of a graphite material.

FIG. 4 illustrates another embodiment of the thermal management structure 100 of the battery cell according to an embodiment of the present invention. That is, in the thermal management structure 100 of the battery cell shown in FIG. 4, the hybrid PCM part 140 may be divided into three divided regions A, B and C, and, as a result, the hybrid PCM part 140 may be formed of three PCMs 142, 144 and 146 having different thermal conductivity.

Here, a first divided region A in which the temperature of the battery cell 110 is highest may be formed of the first synthetic PCM 146 whose relative thermal conductivity is the highest, a second divided region B in which the temperature of the battery cell 110 is the second highest may be formed of the second synthetic PCM 144 whose relative thermal conductivity is the second highest, and a third divided regions C in which the temperature of the battery cell 110 is the lowest may be formed of the reference PCM 142 whose relative thermal conductivity is the lowest. Therefore, the thermal management structure 100 of the battery cell shown in FIG. 4 may perform thermal management for the battery cell 110 in more detail, compared to that of FIG. 2.

Meanwhile, FIG. 5 illustrates modified examples with various types of divided regions A, B and C of the hybrid PCM part 140. A hybrid PCM part 140 shown in (a) of FIG. 5 illustrates three divided regions A, B and C formed to be inclined, a hybrid PCM part 140 shown in (b) of FIG. 5 illustrates a shape wherein one (e.g., the first divided region A) of two divided regions A and B is formed in the center, a hybrid PCM part 140 shown in (c) of FIG. 5 illustrates a shape wherein one (e.g., the first divided region A) of three divided regions A, B and C is formed in an upper part and another one (e.g., the second divided region B) of the three divided regions A, B and C is formed in the center, and a hybrid PCM part 140 shown in (d) of FIG. 5 illustrates a shape wherein one (e.g., the first divided region A) of three divided regions A, B and C is formed in an upper part and another type of plural regions (e.g., the second divided region B) of the three divided regions A, B and C are formed in the center.

However, the present invention is not limited to the examples, and the divided regions A, B and C of the hybrid PCM part 140 of this embodiment may be set and changed in various ways depending upon the temperature gradient pattern of the battery cell 110 as described above.

The operation and effects of the thermal management structure 100 of the battery cell according to an embodiment of the present invention configured as described above are as follows.

As shown in FIG. 3, heat F1 and F2 generated from the battery cell when cooling the battery cell 110 is transferred to the heat transfer sheet 150 through the hybrid PCM part 140, and then transferred to the cooling plate 122 of the cell cooler 120 along the heat transfer sheet 150 and the fin member 130. The heat F1 and F2 transferred to the cooling plate 122 of the cell cooler 120 are discharged to the outside through the heating sink 124.

Here, the heat F1 is very quickly transferred through a synthetic phase change material 144 provided in the first divided region A of the hybrid PCM part 140, and the heat F2 is relatively slowly transferred through a reference phase change material 142 provided in the second divided region B of the hybrid PCM part 140. Accordingly, because the heat transfer amount through the synthetic phase change material 144 is greater than the heat transfer amount through the reference PCM 142, more cooling effect may be obtained in a region with a high heat generation amount of the battery cell 110.

As shown in FIG. 3, the heat H1 and H2 transmitted from the cell cooler 120 when the temperature of the battery cell 110 increases are transferred to the hybrid PCM part 140 along the heat transfer sheet 150 and the fin member 130, and then heat the battery cell 110 through the hybrid PCM part 140.

Here, the upper part of the battery cell 110 is very quickly heated through the synthetic PCM 144 provided in the first divided region A of the hybrid PCM part 140, and the lower part of the battery cell 110 is relatively slowly heated through the reference phase change material 142 provided in the second divided region B of the hybrid PCM part 140. Accordingly, since the heat transfer amount (H1) through the synthetic phase change material 144 is greater than the heat transfer amount (H2) through the reference PCM 142, the temperature increase effect on the upper part of the battery cell 110 that is far away from the cell cooler 120 may be further increased.

Meanwhile, when rapid charging of the battery module is performed at room temperature and the temperature reaches above the melting point of the hybrid PCM part 140, the effect of a heat buffer that greatly reduces the maximum temperature and maximum temperature deviation of the battery cell 110 due to the high latent heat of the hybrid PCM part 140 may be exhibited.

In addition, when cooling or increasing the temperature of the battery module, heat transfer may quickly occur from the cooling plate 122 of the cell cooler 120 to the upper parts of the battery cells 110 through the fin member 130 to which the heat transfer sheet 150 is attached. That is, during cooling or heating, heat transfer occurs from the cooling plate 122 to the fin member 130, and heat transfer quickly proceeds toward the upper part of the battery cell 110 perpendicular to the cooling plate 122 through the heat transfer sheet 150 with a very high thermal conductivity which is attached to the fin member 130.

Here, heat is quickly transferred from the heat transfer sheet 150 to the upper part of the battery cell 110 through the synthetic PCM 144 in the first divided region A located in the upper part of the hybrid PCM part 140 which is far away from the cooling plate 122. On the other hand, due to the reference PCM 142 of the second divided region B located in the lower part of the hybrid PCM part 140 close to the cooling plate 122, heat transfer with the heat transfer sheet 150 less occurs in the lower part of the battery cell 110, compared to the upper part side thereof.

Heat transfer to the upper and lower parts of the battery cell 110 is appropriately controlled by the hybrid PCM part 140 as described above, so that both the upper and lower parts of the battery cell 110 may be cooled or heated uniformly and quickly.

For reference, when the heat transfer sheet 150 having high thermal conductivity is attached to the fin member 130 between the battery cells 110, heat transfer can occur quickly in the vertical direction from the cooling plate 122. Accordingly, the temperature difference between the upper and lower parts of the battery cell 110, which is a problem of the thermal management structure, can be solved.

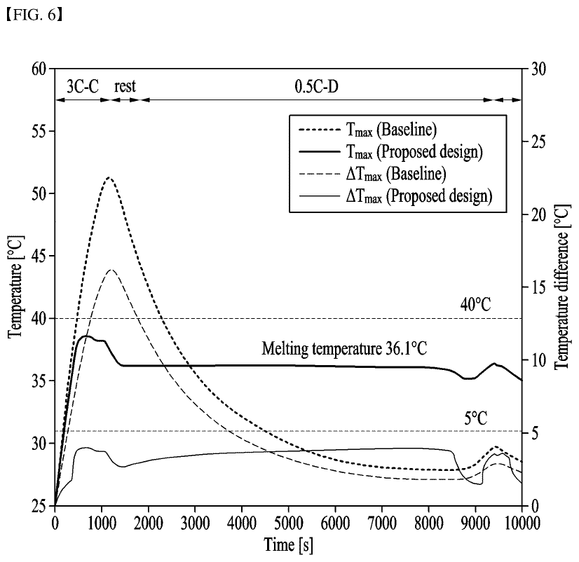

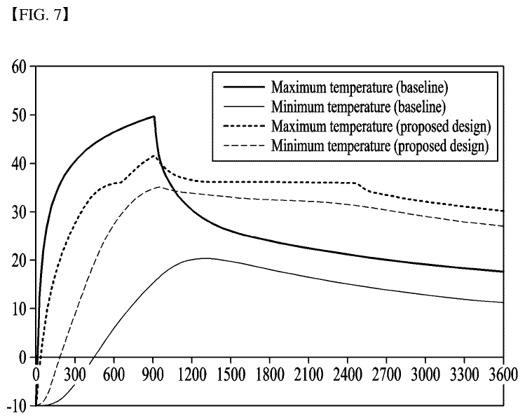

FIG. 6 illustrates a set of graphs representing the maximum temperature and maximum temperature deviation of the battery cell 110 during rapid charging of the battery cell 110 shown in FIG. 1, and FIG. 7 illustrates a set of graphs representing the maximum and minimum temperatures of the battery cell 110 when the temperature of the battery cell 110 shown in FIG. 1 increases.

That is, FIGS. 6 and 7 illustrate graphs of comparative experiments between a battery module (e.g., indicated as “proposed design”), to which the thermal management structure 100 of the battery cell according to this embodiment is applied, and an existing battery module (indicated as “baseline”) to which the thermal management structure 100 of the battery cell according to this embodiment is not applied.

As shown in FIG. 6, during rapid charging of the “proposed design”, the maximum temperature (Tmax) and the maximum temperature deviation (ΔTmax) are overall smaller than those of the “baseline.” In particular, the “proposed design” shows the characteristic of being stably maintained at temperatures below the melting temperature because it utilizes the latent heat of the phase change material, but the “baseline” shows a temperature change that rises above the melting point and then falls rapidly, which may lead to reduced product lifespan and safety issues.

As shown in FIG. 7, when the temperature of the “proposed design increases,” the difference between the maximum temperature and the maximum temperature appears to be overall smaller than that of the “baseline”. In particular, since the “proposed design” uses the latent heat of the PCM, the temperature tends to be maintained horizontally within a certain range, but the “baseline” shows that the temperature changes very rapidly.

As described above, the embodiments of the present invention have been explained with reference to specific details, such as specific components, and limited embodiments and drawings, but these are only provided to help a more general understanding of the present invention, and the present invention is not limited to the embodiments. Various modifications and variations can be made from these descriptions by those with ordinary knowledge in the field to which the present invention belongs. Therefore, it should be understood that the idea of the present invention is not limited to the described embodiments, and not only the accompanying claims, but also all particulars that are equivalent or alternative to the scope of the claims fall into the category of the idea of the present invention.

1. A thermal management structure of a battery cell, the thermal management structure comprising:
a plurality of battery cells repeatedly arranged;
a cell cooler connected to one side of each of the battery cells to enable heat transfer, and configured to cool the battery cell or raise a temperature of the battery when necessary; and
a hybrid phase change material (PCM) part respectively disposed between the battery cells to absorb heat generated from the battery cells, and formed of different types of phase change materials (PCMs) respectively disposed in a plurality of divided regions divided in a shape of corresponding to a temperature gradient pattern of the battery cells.

2. The thermal management structure according to claim 1, wherein the hybrid PCM part is divided into a plurality of divided regions according to the temperature gradient pattern of the battery cells, and
the PCMs disposed in the divided regions are provided to have different thermal conductivities.

3. The thermal management structure according to claim 2, wherein a PCM having a relatively high thermal conductivity among the PCMs is disposed in the divided regions as a temperature of the battery cells corresponding to the divided regions increases, and
a PCM having a relatively low thermal conductivity among the PCMs is disposed in the divided regions as a temperature of the battery cells corresponding to the divided regions is lowered.

4. The thermal management structure according to claim 3, wherein the hybrid PCM part is formed of:
a reference PCM formed only of a pure PCM; and
a synthetic PCM formed to have higher thermal conductivity than the reference PCM by synthesizing a heat transfer material having a higher thermal conductivity than the reference PCM with the reference PCM.

5. The thermal management structure according to claim 4, wherein thermal conductivity of the synthetic PCM is changed by adjusting a content of the heat transfer material synthesized in the reference PCM.

6. The thermal management structure according to claim 5, wherein the heat transfer material comprises at least one of a metal foam, carbon-based material, metal pin and nanomaterial having higher thermal conductivity than the reference PCM.

7. The thermal management structure according to claim 1, further comprising: a fin member made of metal, wherein the fin member contacts one surface of the hybrid PCM part to enable heat transfer, one side of the fin member is connected to the cell cooler, and the fin member serves as a heat transfer path between the hybrid PCM part and the cell cooler.

8. The thermal management structure according to claim 7, further comprising: a heat transfer sheet, wherein the heat transfer sheet is attached to one surface of the fin member in contact with the hybrid PCM part and formed of a material with higher thermal conductivity than the fin member to increase heat transfer performance of the fin member.

9. The thermal management structure according to claim 8, wherein the heat transfer sheet is formed of a graphite material.
